(19) United States
(12) Patent Application Publication
(10) Pub. No.: US 2025/0022061 A1
(43) Pub. Date: Jan. 16, 2025

(54) AUTONOMOUS DECISION MAKING BASED ON PREDICTING FUTURE USER ACTIONS

(71) Applicant: Singleton Foundation, Pasadena, CA (US)

(72) Inventor: Jessica Diane Seubert PATEL, Holmes Beach, FL (US)

(21) Appl. No.: 18/773,401

(22) Filed: Jul. 15, 2024

Related U.S. Application Data
(60) Provisional application No. 63/513,813, filed on Jul. 14, 2023.

(51) Int. Cl. G06Q 40/06; G06Q 20/36

(52) U.S. Cl. CPC G06Q 40/06; G06Q 20/363

(57) ABSTRACT

A method for autonomous decision making includes generating a personality profile for a user. The method also includes tracking spending and/or cash flow of the user. The method further includes determining a current emotional state of the user. The method still further includes predicting one or more financial events corresponding to the user in accordance with the personality profile, the tracked spending and/or cash flow, user data, and/or the current emotional state. The method also includes autonomously performing one or more actions associated with one or more financial accounts of the user in accordance with predicting the one or more financial events.

### CROSS-REFERENCE TO RELATED APPLICATION

The present application claims the benefit of U.S. Provisional Patent Application No. 63/513,813, filed on Jul. 14, 2023, and titled “AUTONOMOUS DECISION MAKING BASED ON AN EMOTIONAL STATE OF A USER,” the disclosure of which is expressly incorporated by reference in its entirety.

### FIELD OF THE DISCLOSURE

Aspects of the present disclosure relate generally to machine learning systems, and more particularly to predicting a future action of a user based on monitoring one or more data feeds and autonomously determining an action based on the predicted future action.

### BACKGROUND

Financial planning is challenging for many individuals due to a combination of factors, including a lack of financial literacy, unpredictable expenses, and emotional spending. Many people struggle to understand complex financial concepts such as investment strategies, tax optimization, and debt management, which can lead to poor financial decisions. Additionally, stress and anxiety may be caused when trying to understand complex financial concepts such as investment strategies, tax optimization and debt management, which can lead to poor financial decisions. This can also be the case for many individuals new to finance with more basic financial concepts, who experience the same stress and make poor financial decisions.

Additionally, the unpredictability of life events, such as medical emergencies or sudden job loss, makes it difficult to maintain a consistent financial plan. Studies state that the average household has two unplanned financial events that happen each year. Emotional spending, driven by stress, social pressures, or the desire for instant gratification, often undermines budgeting efforts and long-term financial goals. Furthermore, balancing short-term needs with long-term aspirations requires disciplined saving and spending habits, which can be hard to maintain without proper guidance and tools. This complexity and the need for ongoing management and adjustment make financial planning a daunting task for many individuals.

Automated financial planning may leverage technology to manage personal finances with minimal human intervention. Conventional automated financial planning systems include round-up saving applications, budgeting tools, robo-advisors automated saving platforms, and financial alert systems. However, these conventional automated financial planning are limited to one task, such as saving, investing, or alerting.

### SUMMARY

In some aspects of the present disclosure, a method for autonomous decision making includes generating a personality profile for a user. The method further includes tracking spending and/or cash flow of the user. The method also includes determining a current emotional state of the user. The method further includes predicting one or more financial events corresponding to the user in accordance with the personality profile, the tracked spending and/or cash flow, user data, and/or the current emotional state. The method still further includes autonomously performing one or more actions associated with one or more financial accounts of the user in accordance with predicting the one or more financial events.

Other aspects of the present disclosure are directed to an apparatus. The apparatus includes means for generating a personality profile for a user. The apparatus further includes means for tracking spending and/or cash flow of the user. The apparatus also includes means for determining a current emotional state of the user. The apparatus still further includes means for predicting one or more financial events corresponding to the user in accordance with the personality profile, the tracked spending and/or cash flow, user data, and/or the current emotional state. The apparatus further includes means for autonomously performing one or more actions associated with one or more financial accounts of the user in accordance with predicting the one or more financial events.

In other aspects of the present disclosure, a non-transitory computer-readable medium with program code recorded thereon is disclosed. The program code is executed by at least one processor and includes program code to generate a personality profile for a user. The program code further includes program code to track spending and/or cash flow of the user. The program code also includes program code to determine a current emotional state of the user. The program code further includes program code to predict one or more financial events corresponding to the user in accordance with the personality profile, the tracked spending and/or cash flow, user data, and/or the current emotional state. The program code still further includes program code to autonomously perform one or more actions associated with one or more financial accounts of the user in accordance with predicting the one or more financial events.

Other aspects of the present disclosure are directed to an apparatus including one or more processors, and one or more memories coupled with the one or more processors and storing processor-executable code that, when executed by the one or more processors, is configured to cause the apparatus to generate a personality profile for a user. Execution of the processor-executable code further causes the apparatus to track spending and/or cash flow of the user. Execution of the processor-executable code also causes the apparatus to determine a current emotional state of the user. Execution of the processor-executable code further causes the apparatus to predict one or more financial events corresponding to the user in accordance with the personality profile, the tracked spending and/or cash flow, user data, and/or the current emotional state. Execution of the processor-executable code still further causes the apparatus to autonomously perform one or more actions associated with one or more financial accounts of the user in accordance with predicting the one or more financial events.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of a decision making system, in accordance with aspects of the present disclosure.

FIG. 2 is a diagram illustrating an example of a hardware implementation for a system, in accordance with aspects of the present disclosure.

FIG. 3 is a flow diagram illustrating an example of an autonomous decision making process, in accordance with one or more aspects of the present disclosure.

FIG. 4 is a block diagram illustrating an example of a system for autonomously taking one or more actions based on predicting one or more events, in accordance with various aspects of the present disclosure.

FIG. 5 is a flow diagram illustrating an example process performed by a decision making module, in accordance with some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

Financial planning is challenging for many individuals due to a combination of factors, including a lack of financial literacy, unpredictable expenses, and emotional spending. Many people struggle to understand complex financial concepts such as investment strategies, tax optimization, and debt management, which can lead to poor financial decisions. Additionally, the unpredictability of life events, such as medical emergencies or sudden job loss, makes it difficult to maintain a consistent financial plan. Emotional spending, driven by stress, social pressures, or the desire for instant gratification, often undermines budgeting efforts and long-term financial goals. Furthermore, balancing short-term needs with long-term aspirations requires disciplined saving and spending habits, which can be hard to maintain without proper guidance and tools. This complexity and the need for ongoing management and adjustment make financial planning a daunting task for many individuals.

Additionally, a person's financial situation can affect their emotional state. Financial difficulties, such as struggling to pay bills, accumulating debt, or living paycheck to paycheck, can lead to chronic stress, anxiety, and a constant sense of worry. Fear and uncertainty about the future can arise from financial instability, job loss, or unexpected financial burdens. These circumstances often give rise to feelings of depression, hopelessness, and a diminished sense of self-worth. Relationships can also suffer as financial strain leads to conflicts and tension. Additionally, financial struggles can contribute to social isolation, limited opportunities for personal growth, and even adverse health effects. For example, studies have shown that poor financial health is tied to heart conditions and more missed days at work Unhealthy coping mechanisms may arise, exacerbating the emotional toll. Seeking professional help can provide support and strategies to manage the impact of financial challenges on emotions.

Automated financial planning may leverage technology to manage personal finances with minimal human intervention. Conventional automated financial planning systems include round-up saving applications, budgeting tools, robo-advisors, automated saving platforms, and financial alert systems. In some examples, round-up saving applications may round up each purchase to the nearest dollar and transfer the difference into a savings or investment account. For example, a $4.75 coffee purchase would round up to $5.00, saving the extra $0.25. Budgeting tools track income and expenses, categorize spending, and provide insights into spending habits, helping users create and stick to budgets by setting spending limits for various categories and sending alerts when these limits are approached. Investment management through robo-advisors uses algorithms to build and manage diversified portfolios based on the user's risk tolerance, financial goals, and time horizon, with continuous monitoring and rebalancing to maintain optimal asset allocation.

Goal setting and tracking tools allow users to set specific financial goals, such as saving for a vacation, building an emergency fund, or paying off debt, and track progress towards these goals with visualizations and recommendations. Debt repayment plans analyze outstanding debts, prioritize payments, and automate repayment to ensure timely repayment, helping users pay off debt efficiently and reduce interest payments. Automated expense management tools sync with bank accounts and credit cards to track and categorize spending in real-time, providing detailed reports and highlighting areas for potential savings. Automated savings plans regularly transfer a predetermined amount from a user's checking to a savings account, building savings consistently over time without manual effort.

Financial alerts and insights notify users about their financial status, including upcoming bill payments, low account balances, unusual spending patterns, or savings and investment opportunities. Advanced tools offer tax optimization strategies like tax-loss harvesting to minimize tax liability and maximize after-tax returns. Additionally, automated tools assist with insurance management by analyzing coverage needs, comparing policies, and recommending appropriate insurance products to ensure adequate protection against risks like health issues, accidents, or property damage.

Conventional automated financial planning tools are reactive. For example, an action of a specific tool may be triggered by an event, such as rounding-up for a purchase or alerting when a stock hits a certain price. Additionally, these conventional tools lack consideration for the user's personality and emotional state. Conventional tools do not account for how a user's financial decisions are influenced by their emotional well-being or their financial personality. For example, a user who tends to overspend when stressed or one who avoids spending out of anxiety about future financial stability may not receive the appropriate guidance from these tools.

It may be desirable to improve automated financial planning tools to be proactive, such that an automated financial planning tool may predict an event and make a decision based on the predicted event. The decision may be an action, such as, but not limited to, adjusting a savings rate or locking a credit card in a certain geographic location. Such tools may offer a more comprehensive and personalized approach to financial management. For example, a proactive tool could analyze a user's past spending patterns, emotional states, and personality profile to predict periods of potential overspending. The proactive tool may then take preemptive actions, such as adjusting the user's savings rate, locking a credit card in a certain geographic location, or blocking specific types of purchases to prevent financial mishaps. In some examples, the proactive tool may also provide helpful information to the use. For example, the proactive tool may transmit a message noting that the user may be stressed out and overspent, as such, the user should take time to reset and replan their finances. The proactive tool may provide tips and/or solutions for managing stress and/or overspending. Additionally, or alternatively, the proactive tool may recommend financial products or incentives.

Various aspects of the present disclosure are directed to an automated financial decision tool that determines one or more actions based on predicting one or more events. In some examples, an autonomous decision making system is proposed that uses various data points to improve and manage a user's financial health. The system integrates data from one or more user devices, such as laptops and smartphones, and financial systems, including banks, credit card companies, and investment platforms. By linking users' financial accounts securely, the system pulls in real-time data on spending habits, cash flows, transaction histories, and account balances. This data, along with a user's personality profile (e.g., financial personality profile) and/or current emotional state, is analyzed using one or more machine learning models to predict future financial events, such as periods of potential overspending, financial strain, or changes in financial behavior. Based on these predictions, the decision making device can take various proactive actions. These actions include adjusting savings rates, modifying 401(k) contribution levels, reallocating investment amounts, setting spending caps, and even blocking or limiting the use of credit cards in certain locations or during specific times to prevent financial missteps.

As discussed, in some examples, the system also considers the user's emotional state, which is input through one or more user devices and/or derived based on an emotional state model. The emotional state may be correlated with spending patterns to provide more personalized financial advice. In some such examples, users may manually update their emotional state over time. Alternatively, the system can analyze user data, such as spending patterns or activities, to infer their emotional state. For example, increased ice cream purchases may suggest happiness or sadness based on the user's personality. As another example, frequent visits to the park could indicate joy. Spending patterns may be determined by monitoring the user's spending in real-time. The user's activities may be derived from spending activity and/or physical location. For example, the user's location may be tracked via a device, such as a mobile phone. The user's activity may be determined based on the location tracking. As discussed, a machine learning model may be used to infer the emotions. The model may be trained on a set of users and refined for specific users. The refinement may be based on express feedback from the respective users.

In some examples, based on the user's emotional updates and/or inferred emotions, the one or more actions may be dynamically performed. If the user indicates being happy, the system may suggest allocating more funds towards experiences or investments that align with their financial personality. Additionally, or alternatively, the system may autonomously allocate more funds toward experiences or investments that align with their financial personality. Conversely, if the user indicates being sad or stressed, the system might recommend reallocating resources toward stress-relief activities or adjusting financial goals accordingly. Additionally, or alternatively, the system may autonomously allocate more funds toward stress-relief activities or adjust financial goals accordingly.

By continuously monitoring and updating based on real-world results, the decision making device assists the user in maintaining financial discipline and achieving their financial goals effectively. This comprehensive approach to financial management helps users navigate their financial journeys with foresight and strategic guidance, ultimately enhancing their overall financial stability and well-being.

Particular aspects of the subject matter described in this disclosure can be implemented to realize one or more of the following potential advantages. In some examples, the described techniques of autonomously performing one or more actions associated with one or more financial accounts of the user in accordance with predicting the one or more financial events may provide several benefits. These benefits include enhancing the user's financial stability by preventing overspending through timely interventions such as setting spending caps or blocking transactions in specific locations. Additionally, by adjusting savings rates, 401(k) contributions, and investment allocations based on real-time financial data and predicted events, users can achieve their financial goals more efficiently. Furthermore, the system can offer personalized financial advice that aligns with the user's emotional state and financial behavior, thereby reducing financial stress and improving overall financial well-being. The autonomous nature of these actions ensures that users receive consistent and proactive financial management without requiring constant manual input, thereby saving time and effort while maintaining optimal financial health.

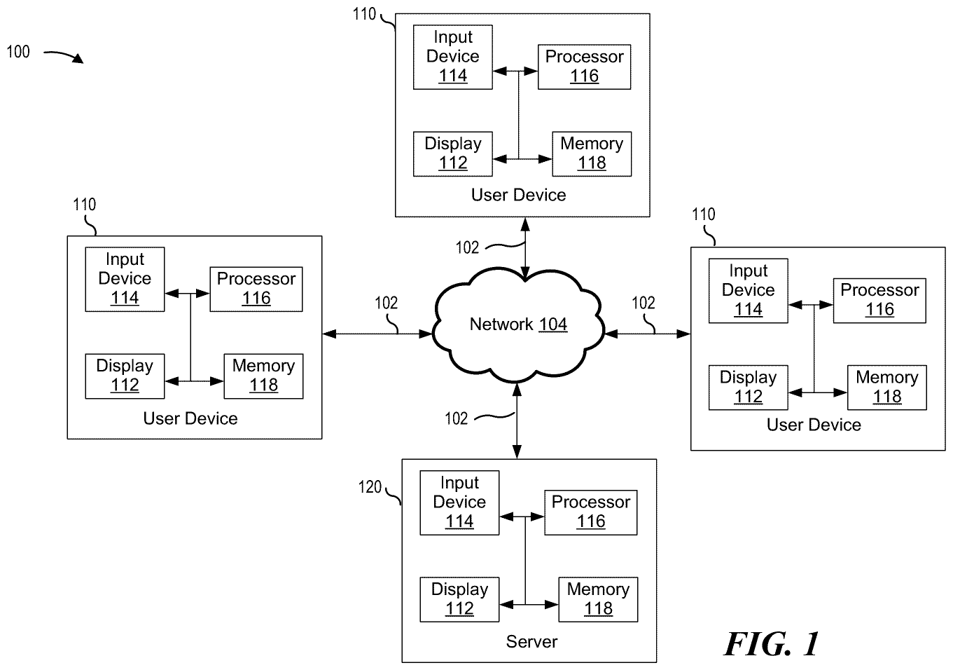

FIG. 1 is a block diagram illustrating an example of a system 100 for monitoring a user's emotional state and autonomously updating one or more parameters associated with the user's financial well-being based on the user's emotional state, in accordance with aspects of the present disclosure. As shown in the example of FIG. 1, the system 100 may include one or more user devices 110 and one or more servers 120. For case of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may include network links, dial-up links, wireless links (e.g., Wi-Fi link, satellite link, or cellular communication link), and/or hard-wired links.

The server 120 may be a computing device, such as a server, processor, computer, cloud computing device, cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to host a machine learning model and communicate via a wireless or wired medium. In some examples, the server 120 may host one or more machine learning models, such as an emotional state model for determining the user's emotional state, a prediction model for predicting one or more future events, and/or a decision making model for determining one or more actions based on the one or more predicted future events. In some such examples, one or more server 120 may work in tandem to host the machine learning model. Specifically, the server 120 may implement functions and/or computer code that runs the machine learning model and/or a site, such as a website, for accessing the one or more machine learning models.

Each user device 110 may be an example of a personal computing device, a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium. A user device 110 may be used by a user to input their emotional state. The interface may be accessed via a website or a dedicate application, such as a mobile phone application. Additionally, or alternatively, the user device 110 may include one or more of an emotional state model for determining the user's emotional state, a prediction model for predicting one or more future events, and/or a decision making model for determining one or more actions based on the one or more predicted future events. In some examples, each user device 110 shown in FIG. 1 may be used by a different user. Each user device 110 and server 120 may be stationary or mobile.

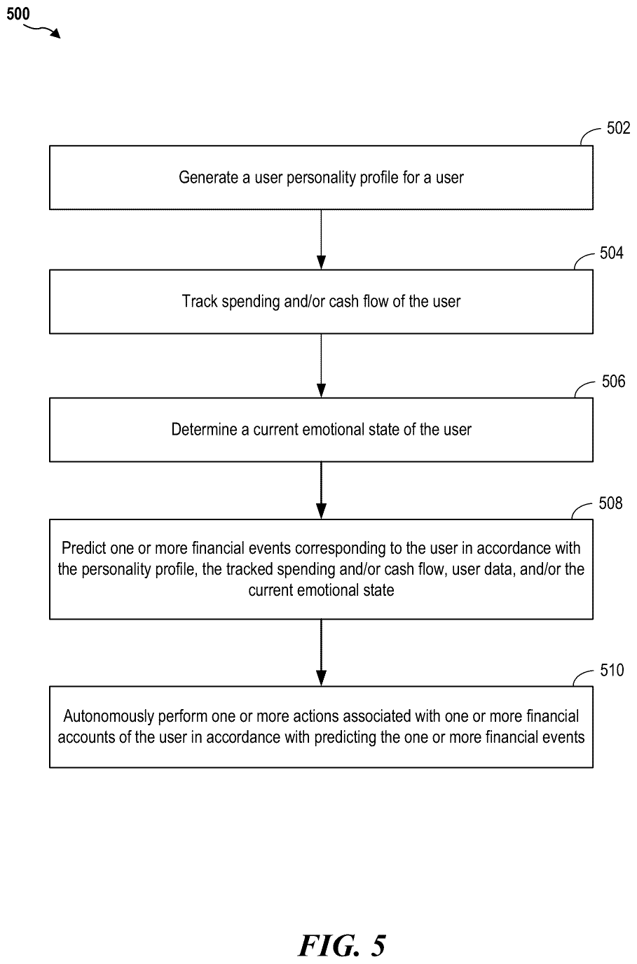

In some examples, each user device 110 may be included inside a housing that houses components of the user device 110, such as one or more processors 116 and a memory 118. The housing may also include, or be connected to, a display 112 and an input device 114, which may be interconnected with other components of the user device 110. For ease of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the emotional state model and/or provide feedback regarding the user's emotional state. Working in conjunction with one or more components of the user device 110, the processor 116 may receive information associated with the emotional state model, and control the display 112 to output information associated with the emotional state model. The display 112 may output (e.g., display) information received at the processor 116. In some examples, the processor 116 of the user device 110 is configured to perform operations and implement one or more elements associated with one or more processes, such as the process 500 described with respect to FIG. 5.

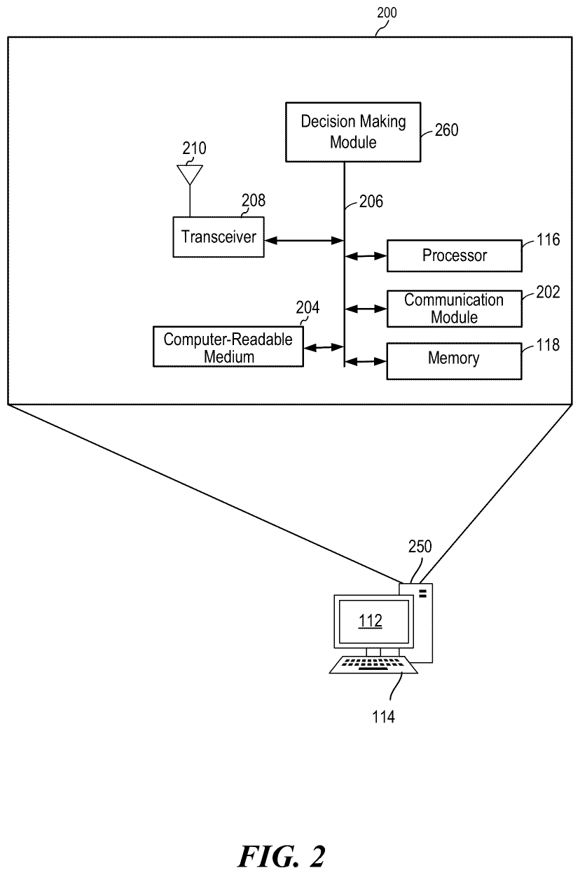

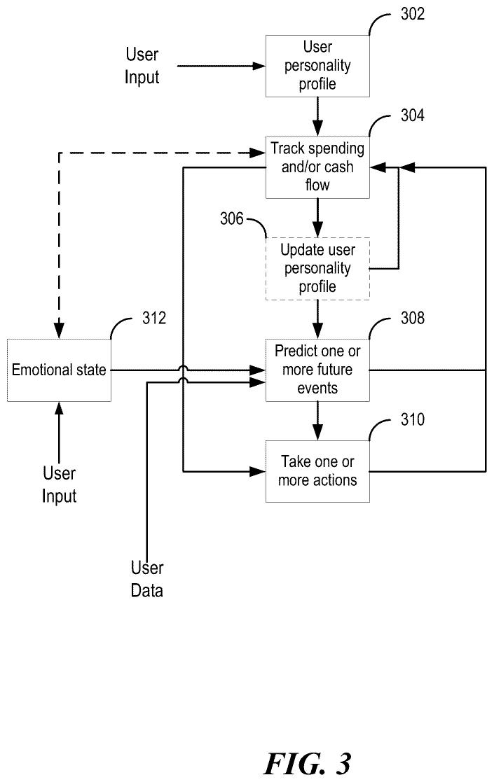

In some examples, an emotional state model host may maintain the server 120. The server 120 may be included inside a housing that houses components of the server 120, such as one or more processors 116 and a memory 118. The housing may also include, or be connected to, a display 112 and an input device 114, which may be interconnected with other components of the user device 110. For ease of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 120 may execute instructions for maintaining the emotional state model, training the emotional state model, and/or executing the emotional state model. In some examples, the processor 116 of the server 120 is configured to perform operations and implement one or more elements associated with one or more processes, such as the process 300 described with respect to FIG. 3. Additionally, or alternatively, the processor 116 of the server 120 may be configured to perform operations associated with the decision making module 260 described with reference to FIG. 2.

FIG. 2 is a diagram illustrating an example of a hardware implementation for a system 200, according to various aspects of the present disclosure. The system 200 may be a component of a device 250. The device may also be referred to as a decision making device 250 (hereinafter used interchangeably). The device 250 may be an example of a user device 110 or a server 120 described with reference to FIG. 1. As shown in the example of FIG. 2, the device 250 may include a display 112 and an input device 114 (e.g., a keyboard). In some examples, one or more modules of the system 200 may be configured to perform operations and implement one or more elements associated with one or more processes, such as the process 500 described with reference to FIG. 5.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

As shown in the example of FIG. 2, the system 200 may include a decision making module 260 for performing operations associated with determining and/or executing one or more actions based on one or more predicted events. Additionally, or alternatively, the decision making module 260 may include one or more machine learning models, such as an emotional state model for determining the user's emotional state, a prediction model for predicting one or more future events, and/or a decision making model for determining one or more actions based on the one or more predicted future events. Each of the one or more machine learning models may be trained to perform a specific task. Additionally, or alternatively, the one or more machine learning models (e.g., the emotional state model, the prediction model, and the decision making model) may be separate models or a combination of one or more models. In some examples, in addition to, or alternate from, using the one or more machine learning models, the decision making module 260 may follow a rules-based approach for determining and/or executing the one or more actions. In some examples, the decision making module 260 may also predict one or more events based on one or more inputs as described herein. In some examples, the decision making model may perform one or more operations such as the operations described with reference to process 500 described with reference to FIG. 500. The decision making module 260 may include artificial or computational intelligence elements, such as, neural network, fuzzy logic, or other machine learning algorithms. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the decision making module 260 to implement one or more elements associated with one or more processes, such as the process 500 described with respect to FIG. 5. The computer-readable medium 204 may also be used for storing data that is manipulated by the processor 116 when executing the software. For example, working in conjunction with one or more of the other modules the modules 116, 118, 202, 204, and 208, the decision making module 260 may perform operations, including operations of the process 300 described with reference to FIG. 3.

As indicated above, FIGS. 1 and 2 are provided as examples. Other examples may differ from what is described with regard to FIGS. 1 and 2.

As discussed, conventional automated financial planning tools are reactive. For example, an action of a specific tool may be triggered by an event, such as rounding-up for a purchase or alerting when a stock hits a certain price. Additionally, conventional automated financial planning tools may not provide any new information to the user. Rather, most conventional automated financial planning tools, such as budgeting applications, simply reformat information that is already available to users. It may be desirable to improve automated financial planning tools to be proactive, such that an automated financial planning tool may predict an event and make a decision based on the predicted event. The decision may be an action, such as, but not limited to, adjusting a savings rate or locking a credit card in a certain geographic location. Various aspects of the present disclosure are directed to an automated financial decision tool that determines one or more actions based on predicting one or more events. In some examples, a financial planning system is proposed that uses scientific research to derive an individual's financial personality. Based on this personality assessment, a personalized financial plan is created, taking into account factors such as risk tolerance, spending habits, and long-term goals.

In some examples, a personality profile may be generated based on a user answering a set of questions associated with a proprietary test (for example, a personality quiz). In such examples, the personality profile may be one personality profile of a group of personality profiles. In some examples, the group of personality profiles includes eight different money personality types, which include the dreamer, the cautious enthusiast, the bold adventurer, the carefree optimist, the thrifty strategist, the thoughtful money manager, the frugal entrepreneur, and the present-focused saver. Aspects of the present disclosure are not limited to eight money personality types, additional or fewer money personality types may be used. The user personality profile may be determined at a same device that includes the decision making module 260 or a different device.

In some examples, the personality quiz may be specified to assess an individual's financial behavior and emotional relationship with money. The personality quiz may include a group of questions, such as, but not limited to, fifteen questions divided across three scales: a spendthrift-tightwad scale, a propensity to plan scale, and a risk propensity scale. The spendthrift-tightwad scale may include questions that evaluate how individuals approach spending money and whether they have difficulty controlling their spending or anxiety about spending money. The propensity to plan scale measures the extent to which individuals plan their finances in the short term, including setting financial goals, consulting their budget, and considering steps to stick to their budget. The risk propensity scale assesses individuals' willingness to take financial risks, their comfort with trying new things, and their preference for safe options versus higher rewards with higher risks. Each scale may be associated with a specific scoring method. For example, the spendthrift-tightwad scale sums responses to create a spend score. The propensity to plan scale averages responses to create a plan score. Finally, the risk propensity scale sums responses to create a risk score. Based on these scores, users are categorized into one of the aforementioned money personality types, which provide insights into their financial behavior and emotional state. This categorization may be used by a financial planning system associated with a decision making model to offer personalized financial advice and anticipate future spending behavior based on a user's emotional and financial patterns.

The dreamer may find it easy to spend money, often planning ahead and willing to take calculated risks. Many entrepreneurs are dreamers, excelling at creating financial plans that involve higher risks to enjoy the freedom of spending their hard-earned savings as they wish. The dreamer may frequently envision exciting ways to use money to create happiness and fulfillment. Their dedication to hard work and diligent planning ensures a solid financial future, actively shaping the life they aspire to lead. However, they sometimes struggle to balance their natural desire to plan and dream for the future with the ease at which they spend money.

The cautious enthusiast enjoys spending money but prefers planning financial decisions in advance and opting for safe choices over taking big risks. Their financial approach reflects a cautious nature, yet they readily spend money when careful plans are made. While prioritizing financial stability, the cautious enthusiast avoids risky investments due to concerns about potential negative outcomes. The cautious enthusiast often invests time in finding the best deals before making purchases. However, their aversion to risk and ease with spending can occasionally hinder their ability to prioritize investing and saving for retirement.

The bold adventurer lives in the moment when it comes to finances. When presented with an opportunity, they seize it, even if it involves some financial risk. Known for the “go big or go home” mentality, bold adventurers rarely hesitate to buy concert tickets or book vacations, especially if it is a good deal or a once-in-a-lifetime experience. They never want to let a good opportunity pass by, which sometimes makes it difficult to stick to a budget and maintain emergency savings.

The carefree optimist tends to spend money easily on things they want, living in the moment without planning ahead or creating a budget. They understand the power of using money to enhance their mood and bring joy to life. However, the carefree optimist may also avoid risky financial decisions, preferring safe bets over big swings. While this allows them to better understand their finances at any given moment, it can sometimes make saving for the future challenging as they embrace the present with enthusiasm and a willingness to spend.

The thrifty strategist thinks long and hard before spending money, often planning for the future and not afraid to take a little risk. They have a strong passion for building a secure financial future through saving and strategic investments. Known for finding excellent deals and making wise financial choices, the thrifty strategist embraces opportunities that align with their long-term financial goals. However, their cautious approach to spending and occasional feelings of guilt or hesitation can sometimes cause them to agonize over purchases, forgetting that spending money can help them enjoy life's pleasures.

The thoughtful money manager may be a careful spender that values saving for the future, preferring stability over uncertain financial investments. Their main goal is to build a strong financial future by planning ahead, making thoughtful financial decisions, and avoiding unnecessary risks. The thoughtful money manager likes to stay on top of their money, understand where every dollar goes, and is great at making and sticking to a budget. However, their reluctance to take even calculated risks makes the thoughtful money manager less likely to invest, and spending money can sometimes feel painful, causing them to forgo purchases that would improve their lives.

The frugal entrepreneur may have an entrepreneurial spirit, recognizing and seizing opportunities, trusting their instincts, and accepting that the best things often carry some risk. The frugal entrepreneur may be mindful and resourceful in managing finances, embracing the present moment, and exploring thrilling possibilities with potential rewards. The frugal entrepreneur may spend time and effort finding the best deals when making purchases, even if unplanned, and typically make spending decisions in the moment, rarely tempted to overspend.

The present-focused saver may prioritize immediate needs over wants and security over risk, with a natural inclination to embrace the present moment rather than extensive future planning. The present-focused saver may be generally reluctant to spend money, tends to pay bills on time, and may likely stick to a budget. Living by the motto “now vs. later,” the present-focused saver navigates financial decisions with caution, avoiding risky investments and focusing on the here and now.

In some examples, the personality profile (for example, money personality profile) is one element in a process for determining and/or executing one or more actions based on a predicted future event. FIG. 3 is a flow diagram illustrating an example of an autonomous decision making process 300, in accordance with one or more aspects of the present disclosure. In the example of FIG. 3, the decision making process 300 may be implemented by one or more components of a device, such as a device 250 described with reference to FIG. 2.

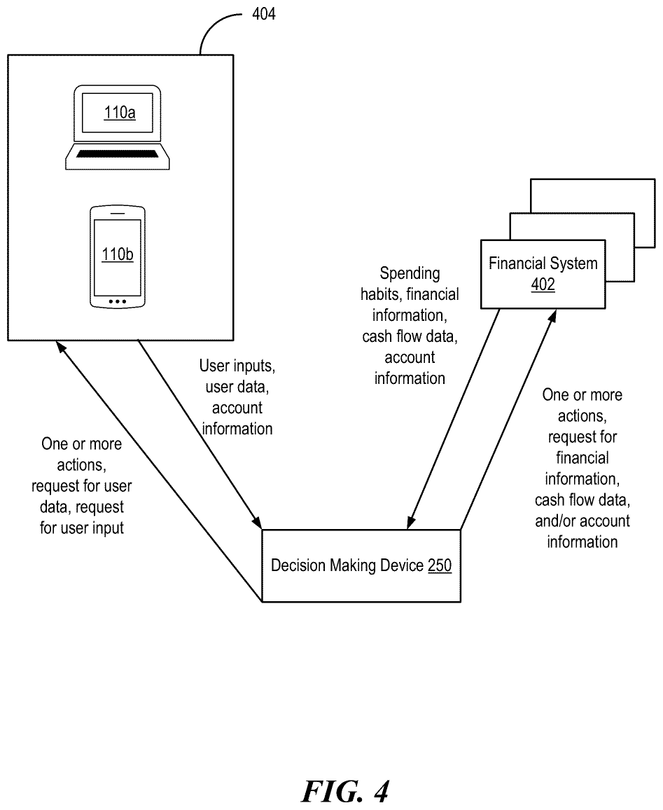

As shown in the example of FIG. 3, at block 302, a user personality profile is generated based on user input. The user input may be received via a user device, such as a user device 110 described with reference to FIG. 1 or a user device 404 described with reference to FIG. 4. As discussed, the user personality profile may be generated based on the user answering a series of questions. The series of questions may determine the user's financial personality, emotional state, and/or other personality traits. For example, the series of questions may be used to determine the user's financial personality type, which may categorize the user as a dreamer, cautious enthusiast, or another defined personality type based on their spending habits, risk tolerance, and/or other information. In some examples, the user is associated with one of eight money personality profiles. However, aspects of the present disclosure are not limited to the eight money personality profiles, additional or fewer money personality profiles may be used. Additionally, the personality profile is not limited to the eight money personality profiles, different types of personality profiles may be used.

After generating the user personality profile, at block 304, the decision making process 300 may track the user's spending habits and cash flow in real-time based on data that is collected and/or monitored from connected bank accounts, credit cards, and other financial sources. The spending habits and cash flow may be used to create a financial profile for the user. The financial profile is different from the user's personality profile. In some examples, the user provides their financial account information to a system, such as a device 250 associated with the decision making process 300. Once this information is provided, the system interacts with various individual financial systems, including banks, credit card companies, investment portfolios, and other financial institutions, to obtain real-time or periodic updates on the user's spending habits and cash flow.

The decision making process 300 may use different techniques to collect this financial data. For some financial systems, data may be pushed automatically to one or more devices (e.g., a system) associated with the decision making process 300 at regular intervals or when specific transactions occur. This push mechanism provides the system with the most up-to-date information without needing to initiate a data request actively. For example, a bank might send transaction details to the system every time a purchase is made, or a credit card company might provide a daily summary of all transactions. Additionally, or alternatively, the system may pull data from other financial systems by sending data requests. This pull mechanism allows the system to retrieve information as needed, such as querying an investment portfolio to update the current value of assets or requesting a summary of monthly expenses from a bank account. This technique ensures that the system can obtain comprehensive financial data even from sources that do not automatically push information.

By leveraging both push and pull data gathering techniques, the system obtains an accurate view of the user's financial situation. This integrated approach allows the system to track spending habits meticulously, such as identifying trends in discretionary spending on luxury items or monitoring significant deviations in spending at specific establishments. For instance, if a user typically spends $150 on shoes at Foot Locker but suddenly spends $400, the system flags this anomaly and integrates the anomaly into the user's financial profile.

The continuous flow of real-time data enables the system to provide timely and relevant financial insights and recommendations. Users benefit from this dynamic interaction as it empowers users to make informed decisions, optimize their spending, and achieve their financial goals more effectively. By understanding and anticipating a user's financial behaviors through detailed data analysis, the system can offer personalized advice and interventions, enhancing overall financial well-being.

The tracking at block 304 may be used to understand the user's spending and cash flow habits, thereby providing a detailed analysis of their expenditure patterns. By categorizing expenses, the decision making process 300 can differentiate between necessary and discretionary spending. For example, the decision making process 300 may identify if the user is spending more on luxury items or non-essential establishments, such as specialty cosmetic stores, sweets shops, high-end clothing boutiques, or gourmet restaurants.

This detailed tracking extends to specific establishments and spending amounts. For example, as discussed, if a user typically purchases shoes from Foot Locker and spends around $150 each time, but suddenly spends $400 at the same store, the system flags this unusual increase in spending. Such deviations from regular spending patterns may be used to determine changes in financial behavior. The decision making process 300 may identify this spike as a potential impulsive purchase, which could be linked to the user's current emotional state, such as stress or excitement.

Additionally, by analyzing these spending habits over time, the decision making process 300 can provide personalized recommendations. For instance, if it notices a user frequently overspending at non-necessity establishments like high-end cosmetic stores, the decision making process 300 may provide a notification (block 310) to the user to suggest budgeting strategies or setting spending limits to curb impulsive purchases. Conversely, if the user is consistently spending within their means on necessary items but occasionally splurges, the decision making process 300 may recognize this as a balanced approach to spending and may advise the user (block 310) on how to maintain this balance while still allowing for occasional indulgences.

In some examples, based on tracking spending and/or cash flow at block 304, the decision making process 300 may update the user personality profile at block 306. This update may be optionally performed. In some such examples, the user personality profile may also be updated based on a user's emotional state. That is, at block 312 the user may provide their emotional state via an application associated with the decision making process 300. The application may reside at the user's device. The emotional state may be periodically received by the user. For example, the emotional state may be provided on a weekly basis or whenever the user accesses a platform (e.g., website or mobile application) associated with the decision making process 300. Additionally, or alternatively, the user may provide their emotional state when answering the series of questions for generating the user personality profile at block 302. The series of questions for generating the user personality profile at block 302 may be presented once when the user initial registers for the platform associated with the decision making process 300.

In some examples, the update to the user personality profile may be performed because the user may have answered one or more questions at a time where they thought or felt something other than their current situation. As such, when the user personality profile is initially generated at block 302, the user profile may not reflect their current personality. Additionally, or alternatively, the user's personality profile may change over time. Therefore, for more accurate advice and/or actions, it may be desirable to periodically update the user personality profile at block 306. In some examples, different weights may be given to the emotional state. For example, a personality profile determined at block 302 may be weighed more than a personality profile derived by the decision making process 300 at block 306, or vice versa.

As an example, the user may be initially categorized as a bold adventurer. This personality type is characterized by a higher propensity for risk-taking and spontaneous spending, particularly under stress. Based on tracking the user's spending patterns, the decision making process 300 may identify frequent trips to gambling destinations, such as Las Vegas or Atlantic City, and significant expenditures during these visits. Additionally, the user regularly reports (block 312) feeling stressed during these periods, which aligns with their overspending behavior. Still, over time, based on the tracking at block 304, the decision making process 300 identifies changes in the user's financial habits and emotional state. For example, their spending habits may be more restrained, even when visiting places where they previously overspent. For example, the user may be planning their finances more diligently, setting budgets, and sticking to them, even during stressful times. The emotional state reports (block 312) may show a shift from frequent stress to more stable emotional conditions, possibly due to improved financial planning and control.

Given these observed changes, the decision making process 300 reassesses the user's financial personality. The reduced frequency of high-risk spending and better emotional management suggest that the user no longer fits the bold adventurer profile. Instead, the user may now align more closely with a different personality type, such as the thrifty strategist or thoughtful money manager. These personality types reflect a more cautious approach to spending, a preference for planning, and lower risk tolerance.

The decision making process 300 may update the user's personality profile to reflect this new behavior pattern. This update may result in more personalized financial advice and recommendations. For instance, instead of warning against potential overspending during stress, the decision making process 300 might now focus on strategies for optimizing savings and investments aligned with the user's new profile. This adaptive process adapts the decision making process 300, such that the decision making process 300 and associated financial wellness tools remain relevant and supportive of the user's evolving financial behaviors and goals. By continuously updating the personality profile based on real-time data, the decision making process 300 improves its ability to guide users towards better financial decisions and improved financial health. After updating the user personality profile at block 306, the decision making process 300 may continue to track spending and/or cash flow at block 304 and/or predict one or more future events at block 308.

As discussed, at block 312, the user may provide their current emotional state, such as happy, sad, stressed, and/or any other type of emotion. The emotional state may be provided via an interface at a user device, such as a user device 110 described with reference to FIG. 1. The user device may transmit the emotional state to the device associated with the decision making process 300. The current emotional state may be combined with tracked spending and/or a tracked cash flow to update a user personality profile and/or predict one or more future events. Additionally, or alternatively, the emotional state may be determined based on the tracked spending and/or cash flow. Additionally, or alternatively, the user personality profile may be a factor in determining the emotional state. In some examples, the emotional states may be weighed differently. For example, a self-reported emotional state determined via user input may be weighed more than an emotional state determined based on the tracked spending and/or cash flow.

Tracking spending and/or cash flow can offer insights into a user's current emotional state, which can, in turn, refine their financial personality profile and improve the prediction of future financial behaviors. As discussed, the decision making process 300 may combine this self-reported emotional state with data from tracked spending and cash flow to update the user's personality profile and predict future events. Alternatively, the tracked spending and/or cash flow may be used exclusively to determine the current emotional state if the user has not provided their emotional state. In one example, if a user reports feeling stressed and the system simultaneously observes a spike in discretionary spending (such as a sudden large purchase or frequent small transactions at entertainment venues), it can correlate stress with impulsive spending behaviors.

Additionally, as discussed, the system can independently infer the user's emotional state based on spending patterns and cash flow data, even if the user does not explicitly report it. For example, a sudden increase in spending on luxury items, dining out, or entertainment might indicate the user is attempting to cope with stress or sadness through retail therapy or seeking comfort. As another example, deviations from usual spending patterns, such as spending more than usual at a specific store or category (e.g., a user typically spends $150 at Foot Locker but suddenly spends $400), can signal emotional upheavals. As another example, a noticeable decrease in spending and an increase in savings might suggest that the user is feeling more cautious or anxious about future financial stability, potentially due to stress or a major life event. As yet another example, if a user with a bold adventurer personality, known for risky spending, suddenly starts saving more and spending less, the system might infer a shift towards anxiety or cautiousness, indicating a potential change in emotional state.

By analyzing these spending and cash flow trends, the decision making process 300 can infer the emotional state of the user with a high degree of accuracy. In some examples, the inferred emotional state may supersede the user reported emotional state. In some examples, this inferred emotional state is then used to update the user's personality profile, ensuring the user's personality profile remains accurate and reflective of their current behavior and emotional condition. For example, the decision making process 300 may change the user's profile from bold adventurer to thrifty strategist if it observes sustained cautious spending and increased savings behavior, combined with emotional indicators of anxiety or cautiousness.

Moreover, predicting future events based on this data becomes more effective. If the decision making process 300 identifies that a user tends to overspend when feeling stressed, it can proactively alert the user during such periods, suggesting strategies to avoid impulsive purchases and maintain financial stability. This proactive approach helps users manage their finances better, ultimately contributing to improved financial well-being.

As shown in the example of FIG. 3, at block 308, the decision making process 300 may predict one or more future events based on one or more of the user personality profiles (blocks 302 and/or 306), the tracked spending and/or cash flow (block 304), the current emotional state (block 312), or user data. The user data may include various data points, such as, but not limited to, content being read or watched and location information, which offer additional context for financial decisions and emotional states. The user data may also include demographic information and/or other information provided by the user when the user registers with the system (e.g., platform) associated with the decision making process 300.

In some examples, one or more applications on one or more user devices may monitor content that the user is engaging with. This may include external content as well as content within a financial system (e.g., website or application) associated with the decision making process 300. For example, a user watching videos on money shame may indicate the user may be struggling with guilt or embarrassment about their financial situation. As another example, a user looking at infographics on how to budget better may suggest the user is taking a proactive approach to managing their finances. By analyzing this content, the decision making process 300 can infer users' current concerns and interests, which can be correlated with their spending habits and emotional state.

Additionally, or alternatively, the user data may include location information. The location information may be tracked via positioning information, such as GPS data. Additionally, or alternatively, the location information may be determined based on spending information, such as the location where purchases were made. Tracking where users spend their money provides insights into their behavior patterns. For example, if a user is frequenting Atlantic City or liquor stores more often than in the past, this could indicate a coping mechanism for stress or emotional distress. Similarly, an increase in visits to specialty shops, such as high-end boutiques or gourmet food stores, might reflect a period of indulgence or significant life events like celebrations. This location data helps the decision making process 300 understand the context behind spending patterns to increase the accuracy of predictions about future behaviors.

In addition to the user data, one or more future events may be predicted based on one or more other data points, such as but not limited to spending habits, timing, ability to save/goals, and/or debt load. Spending habits (tracked at block 304) may be determined by analyzing what users are spending their money on, providing insights into their financial behavior. The decision making process 300 tracks if users are spending more on luxury items or non-necessity establishments like specialty cosmetic stores, sweets shops, high-end restaurants, or entertainment venues. The decision making process 300 may also monitor whether users are spending more than usual at specific establishments, such as a user typically spending $150 on shoes at Foot Locker but suddenly spending $400. Timing of expenditures is another crucial factor, with the decision making process 300 looking for patterns in when users spend their money, such as frequent spending towards the end of a quarter or during holidays. Recognizing these patterns helps predict future spending behaviors and allows the decision making process 300 to provide timely advice or warnings.

The decision making process 300 also evaluates the user's ability to save and progress towards financial goals, checking if users have an emergency fund and are making consistent progress towards their savings goals. This includes tracking if users are saving money from each paycheck and adhering to their financial plans. For instance, if a user consistently saves a portion of their income but suddenly stops, it could indicate financial strain, prompting the decision making process 300 to adjust its recommendations. Analyzing the user's debt load may be helpful in understanding their financial health. The decision making process 300 monitors if a user is carrying a large amount of credit card debt, taking on new loans, or paying off significant sums of debt. For example, a user with a high credit card balance making only minimum payments may be flagged as at risk of financial instability, whereas a user actively paying down large debts might be on a path to improved financial health.

By integrating these data points, the decision making process 300 can make more accurate predictions about future financial events. For example, if a user with previously stable spending habits suddenly increases spending on luxury items and reports feeling stressed, the decision making process 300 might predict potential financial strain and suggest measures to control spending and enhance savings. Conversely, if a user shows improved saving behavior and reduced debt load, the decision making process 300 could recommend investment opportunities aligned with their new financial capacity and goals. This comprehensive analysis ensures that the decision making process 300 provides tailored advice and proactive interventions, helping users achieve better financial outcomes.

The decision making process 300 can predict various future financial events by analyzing and integrating tracked data points such as spending habits, timing, ability to save/goals, and debt load, in addition to the current emotional state and a user personality profile. For instance, if the system observes a pattern where a user significantly increases spending on luxury items and gifts during the holiday season, the decision making process 300 may predict that the user is likely to overspend again in the upcoming holidays. Consequently, the system might send proactive alerts and budgeting tips leading up to the holidays to help the user manage expenses better.

Suppose the system tracks that a user who typically has a steady saving pattern suddenly stops saving and starts spending more on non-essential items like dining out and entertainment. Combined with reports of feeling stressed, the decision making process 300 might predict potential financial strain or upcoming financial difficulty. The decision making process 300 may then suggest the user review their budget, cut unnecessary expenses, and focus on building an emergency fund.

As another example, if a user frequently spends close to their credit limit and only makes minimum payments, the decision making process 300 can predict that the user is at risk of accumulating unsustainable debt levels. The system may recommend strategies to manage and reduce debt, such as consolidating high-interest debt or setting up automatic payments to avoid late fees. In yet another example, for a user who consistently saves a portion of their paycheck and is progressing toward a specific financial goal, like buying a home, the decision making process 300 may predict when the user will likely reach this goal based on their current savings rate. The system might provide encouragement and suggest additional ways to boost savings, such as investing in higher-yield accounts. In another example, if the system identifies that a user with a bold adventurer personality type tends to make large, impulsive purchases when feeling stressed, it can predict similar behavior in future stressful periods. The decision making process 300 might then issue warnings during high-stress times and suggest alternative stress-relief methods that do not involve financial risk, like engaging in free recreational activities.

By analyzing spending patterns and timing, such as frequent high expenditures towards the end of the month, the decision making process 300 can predict budget shortfalls. For instance, if a user tends to run out of funds before their next paycheck, the system might recommend adjusting their budget to distribute expenses more evenly throughout the month or identifying areas where they can cut back. As another example, if a user who was previously focused on paying off debt suddenly starts investing heavily in stocks, the decision making process 300 might predict a shift in financial priorities. The decision making process 300 may then update the user's profile and provide tailored advice on balancing investment risks with ongoing debt management. By predicting these and other future events based on comprehensive data analysis, the decision making process 300 helps users navigate their financial journeys with foresight and strategic guidance, ultimately leading to better financial outcomes.

After predicting one or more future events, at block 310, the decision making process 300 may take or more actions based on predicting the one or more future events. The one or more actions are not limited to providing suggestions. The one or more actions may include actions such as blocking the use of linked payment cards in specific locations, at specific times, for specific items, and/or at specific stores. Additionally, or alternatively, the one or more actions may include adjusting (e.g., increasing or decreasing) a savings amount, a 401(k) contribution rate, an investment amount, and/or other financial adjustments. The one or more actions may be performed based on communications between the system associated with the decision making process 300 and one or more financial institutions or platforms that have been linked with the system. For example, the system associated with the decision making process 300 may have permission from the one or more financial institutions or platforms and/or the user to autonomously perform the one or more actions. Additionally, or alternatively, the system may communicate the one or more actions to respective financial institutions or platforms, such that the respective financial institutions or platforms perform the one or more actions.

In some examples, the user may be notified of the one or more actions. The notification may be through a push message via an application associated with the decision making process 300, such that the notification appears on one or more user devices. Additionally, or alternatively, the notification may be via an electronic message, such as a text message (e.g., SMS message), e-mail, or other type of message. In some other examples, the user is not notified of the one or more actions.

As discussed, the one or more actions are not limited to providing suggestions but can include proactive and preventive measures to manage the user's financial behavior and ensure financial stability. For example, the decision making process 300 can block the use of payment cards (e.g., credit cards, debit cards, electronic payment cards, and/or other types of payment devices) in specific locations where the user is likely to overspend, such as casinos or luxury resorts, or at certain times, like late at night when the user tends to make unnecessary purchases. Additionally, the decision making process 300 can restrict purchases of particular items that the user tends to buy impulsively, such as high-end electronics or designer clothes, and limit transactions at stores where the user has a history of overspending, like high-end department stores.

The decision making process 300 can also make various financial adjustments, such as automatically increasing or decreasing the amount of money being transferred to savings accounts. For example, if the user receives a large bonus, the system might allocate a higher percentage of that bonus to savings to ensure long-term financial security. In some examples, the decision making process 300 can modify the user's 401(k) contribution rates, increasing them if the user is on track to meet their retirement goals to take advantage of tax benefits and compound growth, or decreasing them if the user needs more liquidity. The system can adjust the amount of money being invested in various financial instruments based on the user's current financial situation and goals. For instance, if the user is facing high debt, it might decrease investment amounts and direct more funds towards debt repayment.

Furthermore, the decision making process 300 can implement debt repayment strategies by setting up automatic transfers to pay off high-interest debt, ensuring that the user systematically reduces their debt burden. In some examples, the decision making process 300 can adjust the user's budget to reflect changes in their financial situation, reallocating funds from discretionary spending to savings or debt repayment if it detects increased spending on non-essential items. The system can also set up alerts for unusual or excessive spending, such as notifying the user if their spending on dining out suddenly spikes, and suggesting ways to cut back. In some examples, the decision making process 300 can automatically increase contributions to an emergency fund if it detects that the user's financial situation is precarious, prioritizing building up a cash reserve if the user's job is at risk.

Additionally, the decision making process 300 can impose spending caps on certain categories or overall monthly spending to prevent the user from exceeding their budget. For example, if the user tends to overspend on entertainment, the system might set a limit on how much can be spent in that category each month. In some cases, the decision making process 300 may temporarily freeze certain accounts to prevent any spending until the user's financial situation stabilizes, such as freezing discretionary spending accounts to preserve essential funds if the system detects that the user is about to enter a financial crisis. By implementing these actions, the decision making process 300 not only advises users but also actively intervenes to help them maintain financial discipline and achieve their financial goals, ensuring that users are better equipped to handle their finances responsibly, avoid unnecessary debt, and build a more secure financial future.

In one example, the decision making process 300 may detect that a user has received a large bonus and subsequently booked a flight to Las Vegas. The flight to Las Vegas may be determined based on tracking user data and/or spending data. In such an example, the decision making process 300 may anticipate potential overspending, especially if the user has a history of poor financial management and a high debt load. In this example, the decision making process 300 may take several precautionary actions to prevent financial missteps. In one example, the decision making process 300 may reduce an amount of cash the user can withdraw from ATMs to limit the availability of liquid funds that might be spent impulsively. Additionally, the decision making process 300 may put spending limits on the user's credit cards or other payment instruments (e.g., electronic payment cards or spending platforms) to prevent excessive charges. For credit cards with high balances, the decision making process 300 may temporarily block their use, ensuring that the user does not accumulate further debt in a financially risky environment like Las Vegas.

These actions are designed to protect the user from making decisions that could worsen their financial situation. By limiting access to funds and controlling spending capabilities, the decision making process 300 helps the user stay within a manageable financial framework.

As discussed, one or more machine learning models may be used to determine a user's emotional state, predict one or more future events, and take one or more actions. Each model may be trained individual or in any combination. To predict one or more future events and to take corresponding actions, a machine learning model can be trained through a process involving data collection, feature engineering, model selection, training, and/or evaluation. Initially, historical data on different users' financial transactions, spending habits, cash flow, and emotional states is gathered. This data includes bank statements, credit card transactions, investment portfolios, user-reported emotional states, and engagement with financial content. Demographic data, such as age, income, employment status, and financial goals, is also collected to provide additional context for understanding financial behavior. Additionally, or alternatively, feature engineering may be performed to create meaningful features from the raw data. These features represent critical aspects of user behavior, such as monthly spending totals, savings rates, frequency of specific types of purchases (e.g., luxury vs. necessity), debt-to-income ratio, and temporal patterns of financial activity. Temporal features, such as spending patterns around payday or during holidays, help capture trends over time.

Appropriate machine learning functions are then selected based on the nature and complexity of the data. Some choices include regression models, decision trees, random forests, gradient boosting machines, and neural networks. Ensemble methods, which combine multiple algorithms, may also be used to enhance predictive accuracy. The model is trained by splitting the data into training and validation sets. Cross-validation techniques ensure the model generalizes well to unseen data and helps tune hyperparameters. The model's performance is evaluated using metrics like accuracy, precision, recall, F1 score, AUC-ROC, MAE, or RMSE, depending on the specific task. Validation with a separate test set ensures the model accurately predicts future events, such as periods of overspending or financial strain.

To take actions based on these predictions, the possible actions the system can take are identified, including blocking card usage, adjusting savings or investment amounts, setting spending caps, and sending alerts. The action model may be trained using supervised learning techniques with historical data where actions were previously taken and their outcomes. Labeled datasets may be created with financial and behavioral features as inputs and actions taken as outputs. Reinforcement learning may also be implemented, where the model learns to take actions by receiving feedback on their effectiveness. A reward function quantifies the success of actions, such as improved savings rates or reduced debt.

The action model's performance is tested by simulating various financial scenarios and measuring the effectiveness of the actions taken. Continuous monitoring of real-world outcomes ensures the model remains effective and adapts to new data and behaviors. Finally, the trained models are deployed in a live environment where they predict future events and take actions in real-time. Monitoring systems track the performance and impact of the models, ensuring they provide relevant and accurate guidance, ultimately enhancing users' financial well-being.

Training a model to determine a user's emotional state may include one or more steps, beginning with data collection and preprocessing. Initially, datasets may be gathered, including self-reported emotional states through surveys or prompts within the application, detailed financial transaction records, behavioral data on user interactions with financial content, and external factors such as economic indicators and news events. These datasets provide a foundation for understanding the user's financial behavior and emotional indicators.

Next, feature engineering may be performed to create relevant features from the raw data. This includes analyzing spending patterns, such as average daily spending, frequency of large purchases, and deviations from usual habits. Temporal features, such as end-of-month spending spikes or increased weekend expenditures, are also extracted. Additionally, the types of financial content consumed, such as stress-relief articles versus investment advice, and external events like economic downturns or personal life events, are incorporated to enhance the model's predictive power.

The collected data is then labeled with the user's emotional states, correlating periods of specific financial behaviors with self-reported emotions. For example, frequent high expenditures during reported periods of stress are used to create labeled examples. With this labeled dataset, appropriate machine learning algorithms may be selected for the task. Supervised learning models, such as logistic regression, decision trees, random forests, support vector machines (SVM), and neural networks, may be used for classification tasks, while natural language processing (NLP) models like sentiment analysis tools or transformers (e.g., BERT) are applied if text data from user inputs or content interactions is used.

The model is trained by splitting the dataset into training and validation sets. During the training phase, the model learns to recognize patterns associated with different emotional states, mapping input features to corresponding emotional labels. In the validation phase, the model's performance is evaluated on a separate set to fine-tune parameters and avoid overfitting. Key performance metrics such as accuracy, precision, recall, F1 score, and confusion matrices are used to assess the model's effectiveness and identify areas for improvement.

To maintain and enhance the model's accuracy over time, continuous learning is implemented. Real-time feedback from users is incorporated to refine predictions, and periodic retraining with new data ensures the model adapts to changing user behaviors and external conditions. Adaptive learning techniques are also employed, allowing the model to continuously learn from new data streams without explicit retraining sessions.

For example, consider a user who frequently reports feeling stressed and exhibits increased spending on non-essential items like dining out or entertainment during these periods. The model learns to associate this spending pattern with stress. Over time, the model can predict that similar spending spikes in the future may indicate the user is likely experiencing stress again, even without a self-reported emotional state. The system can then take proactive actions, such as providing financial advice or sending alerts to help the user manage their finances better.

By following these steps, a machine learning model may be trained to determine a user's emotional state based on their financial behavior and interactions. This approach provides valuable insights that can enhance personalized financial management and support, helping users achieve better financial outcomes. A similar approach may be used to train a model for determining or updating a user's personality profile.

In some examples, once the machine learning models for determining an emotional state, determining or updating a user's personality profile, predicting future events, and/or taking actions are deployed, they must be continuously updated based on real-world results to maintain their accuracy and relevance. In some examples, as users interact with the system, new data is continuously collected. This includes updated financial transactions, changes in spending habits, variations in cash flow, and any new self-reported emotional states. The decision planning process 300 (e.g., system) may also gather data on the outcomes of the actions taken, such as whether blocking a payment card prevented overspending or if adjusting savings rates improved financial stability.

A feedback loop may be established where the real-world results of the model's predictions and actions are monitored. For example, if the system predicted that a user would overspend during a particular period and took preventive actions, the actual spending behavior is analyzed to see if the prediction was accurate and if the actions were effective. Key performance metrics may be continuously evaluated to assess the model's effectiveness. These metrics may include the accuracy of spending predictions, the success rate of interventions (e.g., how often blocking a card prevented financial strain), user satisfaction scores, and overall improvements in financial health (e.g., reduced debt, increased savings).

Based on the performance metrics and feedback loop, the models are periodically retrained. New data may be incorporated into the training sets to ensure the models adapt to changing user behaviors and financial patterns. For example, if users start spending differently due to economic changes or personal life events, the new data will help the models adjust their predictions and recommended actions accordingly. If certain patterns that were not previously considered are detected, the algorithms themselves may be adjusted. For example, if it becomes clear that users exhibit new spending behaviors under specific conditions (e.g., during a pandemic or economic downturn), the models can be updated to factor in these new conditions. This may involve adjusting the algorithms to give more weight to certain features or incorporating entirely new features into the models.

Direct feedback from users about the system's performance and recommendations is useful. If users consistently report that certain actions were helpful or unhelpful, this feedback can be used to refine the models. For example, if many users find that receiving alerts about overspending is more effective than having their cards blocked, the model can be adjusted to favor alerts over card blocks in similar future scenarios. In some examples, advanced techniques such as adaptive learning can be implemented, where the model learns and updates itself based on a continuous stream of data without requiring manual retraining. This approach allows the model to adapt more quickly to new patterns and behaviors, ensuring real-time relevance and accuracy.

In some cases, the one or more models may also be tested and updated through scenario simulations. By running simulations based on hypothetical scenarios, the system can predict how changes in user behavior or economic conditions might impact financial decisions and outcomes. These simulations help fine-tune the models before applying them to real-world data.

In some examples, periodic reviews of the model's performance are conducted by data scientists and financial experts. These reviews involve deep dives into the model's predictions and actions, identifying any biases or inaccuracies, and making necessary adjustments. Regular updates ensure that the models stay aligned with the latest financial trends and user behaviors.

FIG. 4 is a block diagram illustrating an example of a system for autonomously taking one or more actions based on predicting one or more events, in accordance with various aspects of the present disclosure. As shown in the example of FIG. 4, the system includes a decision making device 250 that interacts with a set of user devices 404 and one or more financial systems 402 to manage financial data and take actions based on that data. The set of user devices 404 may include one or more user devices, such as a first device 110a, such as a laptop or desktop computer, and/or a second device 110b, such as a smartphone or tablet. These devices 404 may be used by the user to interact with the decision making device 250 to provide inputs such as emotional states, financial goals, and real-time transaction data.

The decision making device 250 may act as the central hub for processing and analyzing data from user devices 404 and financial systems 402. The decision making device 250 may use one or more machine learning models to predict future financial events and take appropriate actions to manage the user's finances. In some examples, users link their financial accounts, including bank accounts, credit cards, and investment portfolios, to the decision making device 250 via secure authentication methods. This linking allows the device 250 to pull in real-time data about spending habits and cash flows. For example, once a bank account is linked, the decision making device can receive transaction details, account balances, and cash flow data directly from the financial system 402.

The decision making device 250 may also communicate with the one or more financial systems 402 to fetch detailed financial data, such as transaction histories, spending categories, and cash flow patterns. This communication can occur through both pull mechanisms, where the device requests data periodically or in real-time, and push mechanisms, where financial systems automatically send updates as transactions occur. Based on the analysis of spending habits and cash flows, the decision making device 250 can adjust the user's savings rate, such as increasing it if there is an increase in disposable income to enhance financial stability. Additionally, the decision making device 250 can take preventive actions like blocking or limiting the use of credit cards if it predicts potential overspending based on the user's emotional state and spending patterns. It can also make other financial adjustments, such as modifying investment amounts, reallocating funds to pay off debts, or setting up automated transfers to build an emergency fund.

In summary, the decision making device 250 integrates data from user devices 404 and financial systems 402 to manage and optimize the user's financial health. By linking bank accounts, credit cards, and other financial information, the device receives comprehensive data on spending habits and cash flows. The decision making device 250 uses this data to predict future financial events and take proactive actions, such as adjusting savings rates and blocking cards, to ensure the user's financial stability and well-being.

According to various aspects of the present disclosure, the decision making system creates a positive, encouraging environment to help users learn about personal finance and develop good financial habits. On the user side, individuals can engage with personal finance topics, set and track financial goals, monitor their saving and spending habits, and usc a retirement savings calculator. Users may earn badges for making progress toward goals, reaching milestones, engaging with content, feeling better about their finances, and using tools like the cash flow sheet and retirement calculator. An interactive feature, represented by, for example, a user interface element, may provide words of encouragement and display the users' earned badges and progress.

In some examples, when initially registering for the decision making system, a user logs into a secure site, creates a password, and enters demographic information (age, gender, education level, ZIP code). The user then takes a scientifically-based money personality test developed by behavioral researchers using validated academic scales. As discussed, the user may be categorized into one of eight different personality types. The user may be asked to periodically update their current feelings. These feelings may be specifically about their finances, ranging from anxious to great.

On the administrative side, demographic information is combined with users' selected feelings, set goals, progress, and content engagement. This data allows administrators to identify impactful correlations between demographics and financial behavior, such as goal achievement, personality type, and preferred content style. These correlations help tailor content to users based on their demographics and behavior patterns. This demographic data may be parsed among different partner groups such as universities, companies, and nonprofits. Being able to compare the data collectively allows the system to notice trends in the data. For instance, the system might identify that men aged 18-25 in the Midwest prefer video content and are more likely to set savings goals after watching three videos, while women aged 30-45 in the Northeast feel less anxious about their money once their debt is reduced to $1,000 or less.

In some examples, this data is used to guide users in their content choices and customize the system's interactions with them, using the user interface to facilitate communication while the user is logged in to the system. As discussed, in some examples using security protocols, the system may link to bank accounts and other financial accounts, offering personalized financial guidance based on users' personality types, emotional status, cash flow, and/or spending habits. In some examples, demographic information is also used. For example, the system may recommend specific bank accounts or investments that align with a user's personality profile or suggest vacation locations for those with a vacation savings goal. The platform may also develop more robust personality profiles correlated with other data points to provide even more granular guidance and possibly connect users to financial advisors.

FIG. 5 is a flow diagram illustrating an example process 500 performed by a decision making module 260, in accordance with some aspects of the present disclosure. The decision making module 260 may be associated with a system 200 described with reference to FIG. 2. The example process 300 is an example of taking one or more actions based on one or more events that are predicted in accordance with tracking a user's spending and/or cash flow, as well as a user's personality profile and current emotional state.

As shown in FIG. 5, the process 500 begins at block 502 by generating a personality profile for a user. In some examples, the personality profile is a financially personality profile that is generated in accordance with the user answering one or more questions via a web interface. At block 504, the process 500 tracks spending and/or cash flow of the user. In some examples, the personality profile may be updated based on tracking the spending and/or cash flow. In such examples, the personality profile used for predicting the one or more financial events may be the updated personality profile.

At block 506, the process 500 determines a current emotional state of the user. At block 508, the process 500 predicts one or more financial events corresponding to the user in accordance with the personality profile, the tracked spending and/or cash flow, user data, and/or the current emotional state. The user data may include user location information over a period of time, user content consumption habits, and/or user demographic information. The current emotional state may be determined via user input and/or the tracked spending and/or cash flow.

At block 510, the process 500 autonomously performs one or more actions associated with one or more financial accounts of the user in accordance with predicting the one or more financial events. The one or more actions may include adjusting a savings rate, a 401K contribution rate, and/or an investment strategy, limiting use of one or more financial instruments at a geographic location, for one or more types of items, and/or at one or more merchants; and/or, limiting an amount that can be spent or withdrawn via the one or more financial instruments. In some examples, current emotional may be determined via an emotional state machine learning model, the one or more financial events may be predicted via a financial events machine learning model; and the one or more actions may be autonomously performed via an action machine learning model.

Implementation examples are described in the following numbered clauses:
Clause 1. A method for autonomous decision making, comprising: generating a personality profile for a user; tracking spending and/or cash flow of the user; determining a current emotional state of the user; predicting one or more financial events corresponding to the user in accordance with the personality profile, the tracked spending and/or cash flow, user data, and/or the current emotional state; and autonomously performing one or more actions associated with one or more financial accounts of the user in accordance with predicting the one or more financial events.
Clause 2. The method of Clause 1, wherein the personality profile is a financially personality profile that is generated in accordance with the user answering one or more questions via a web interface.
Clause 3. The method of any one of Clause 1-2, further comprising updating the personality profile based on tracking the spending and/or cash flow, wherein the personality profile used for predicting the one or more financial events is the updated personality profile.
Clause 4. The method of any one of Clause 1-3, wherein the user data includes user location information over a period of time, user content consumption habits, and/or user demographic information.
Clause 5. The method of any one of Clause 1-4, wherein the one or more actions include: adjusting a savings rate, a 401K contribution rate, and/or an investment strategy; limiting use of one or more financial instruments at a geographic location, for one or more types of items, and/or at one or more merchants; and/or limiting an amount that can be spent or withdrawn via the one or more financial instruments.
Clause 6. The method of any one of Clause 1-5, wherein the current emotional state is determined via user input and/or the tracked spending and/or cash flow.
Clause 7. The method of any one of Clause 1-6, wherein: the current emotional is determined via an emotional state machine learning model; the one or more financial events are predicted via a financial events machine learning model; and the one or more actions are autonomously performed via an action machine learning model.
Clause 8. An apparatus comprising a processor, memory coupled with the processor, and instructions stored in the memory and operable, when executed by the processor to cause the apparatus to perform any one of Clauses 1-7.
Clause 9. An apparatus comprising at least one means for performing any one of Clauses 1-7.
Clause 10. A computer program comprising code for causing an apparatus to perform any one of Clauses 1-7.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “and/or” refers to any combination of items, including single members. As an example, “a, b, and/or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for autonomous decision making, comprising:
generating a personality profile for a user;
tracking spending and/or cash flow of the user;
determining a current emotional state of the user;
predicting one or more financial events corresponding to the user in accordance with the personality profile, the tracked spending and/or cash flow, user data, and/or the current emotional state; and
autonomously performing one or more actions associated with one or more financial accounts of the user in accordance with predicting the one or more financial events.

2. The method of claim 1, wherein the personality profile is a financially personality profile that is generated in accordance with the user answering one or more questions via a web interface.

3. The method of claim 1, further comprising updating the personality profile based on tracking the spending and/or cash flow, wherein the personality profile used for predicting the one or more financial events is the updated personality profile.

4. The method of claim 1, wherein the user data includes user location information over a period of time, user content consumption habits, and/or user demographic information.

5. The method of claim 1, wherein the one or more actions include:
adjusting a savings rate, a 401K contribution rate, and/or an investment strategy;
limiting use of one or more financial instruments at a geographic location, for one or more types of items, and/or at one or more merchants; and/or
limiting an amount that can be spent or withdrawn via the one or more financial instruments.

6. The method of claim 1, wherein the current emotional state is determined via user input and/or one or both of the tracked spending or cash flow.

7. The method of claim 1, wherein:
the current emotional is determined via an emotional state machine learning model;
the one or more financial events are predicted via a financial events machine learning model; and
the one or more actions are autonomously performed via an action machine learning model.

8. An apparatus for autonomous decision making, comprising:
one or more processors; and
one or more memories coupled with the one or more processors and storing processor-executable code that, when executed by the one or more processors, is configured to cause the apparatus to:
generate a personality profile for a user;
track spending and/or cash flow of the user;
determine a current emotional state of the user;
predict one or more financial events corresponding to the user in accordance with the personality profile, the tracked spending and/or cash flow, user data, and/or the current emotional state; and
autonomously perform one or more actions associated with one or more financial accounts of the user in accordance with predicting the one or more financial events.

9. The apparatus of claim 8, wherein the personality profile is a financially personality profile that is generated in accordance with the user answering one or more questions via a web interface.

10. The apparatus of claim 8, wherein:
execution of the processor-executable code further causes the apparatus to update the personality profile based on tracking the spending and/or cash flow; and
the personality profile used for predicting the one or more financial events is the updated personality profile.

11. The method of claim 8, wherein the user data includes user location information over a period of time, user content consumption habits, and/or user demographic information.

12. The apparatus of claim 8, wherein the one or more actions include:
adjusting a savings rate, a 401K contribution rate, and/or an investment strategy;
limiting use of one or more financial instruments at a geographic location, for one or more types of items, and/or at one or more merchants; and/or
limiting an amount that can be spent or withdrawn via the one or more financial instruments.

13. The apparatus of claim 8, wherein the current emotional state is determined via user input and/or one or both of the tracked spending or cash flow.

14. The apparatus of claim 8, wherein:
the current emotional is determined via an emotional state machine learning model;
the one or more financial events are predicted via a financial events machine learning model; and
the one or more actions are autonomously performed via an action machine learning model.

15. A non-transitory computer-readable medium having program code recorded thereon for autonomous decision making, the program code executed by one or more processors and comprising:
program code to generate a personality profile for a user;
program code to track spending and/or cash flow of the user;
program code to determine a current emotional state of the user;
program code to predict one or more financial events corresponding to the user in accordance with the personality profile, the tracked spending and/or cash flow, user data, and/or the current emotional state; and
program code to autonomously perform one or more actions associated with one or more financial accounts of the user in accordance with predicting the one or more financial events.

16. The non-transitory computer-readable medium of claim 15, wherein the personality profile is a financially personality profile that is generated in accordance with the user answering one or more questions via a web interface.

17. The non-transitory computer-readable medium of claim 15, wherein:
the program code further comprises program code to update the personality profile based on tracking the spending and/or cash flow; and
the personality profile used for predicting the one or more financial events is the updated personality profile.

18. The non-transitory computer-readable medium of claim 15, wherein the user data includes user location information over a period of time, user content consumption habits, and/or user demographic information.

19. The non-transitory computer-readable medium of claim 15, wherein the one or more actions include:
adjusting a savings rate, a 401K contribution rate, and/or an investment strategy;
limiting use of one or more financial instruments at a geographic location, for one or more types of items, and/or at one or more merchants; and/or
limiting an amount that can be spent or withdrawn via the one or more financial instruments.

20. The non-transitory computer-readable medium of claim 15, wherein the current emotional state is determined via user input and/or one or both of the tracked spending or cash flow.
